(19) United States
(12) Patent Application Publication
(10) Pub. No.: US 2009/0153423 A1
(43) Pub. Date: Jun. 18, 2009

(54) WIRELESS COMMUNICATION DEVICE WITH A MULTI-BAND ANTENNA SYSTEM

(75) Inventors: CARLO DINALLO, PLANTATION, FL (US); GIORGI G. BIT-BABIK, SUNRISE, FL (US); PETER C. SONG, BIRMINGHAM (GB)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/955,791

(22) Filed: Dec. 13, 2007

(51) Int. Cl. H01Q 9/04; H01Q 13/10

(52) U.S. Cl. 343/767; 343/700 MS

(57) ABSTRACT

Disclosed is an apparatus for a wireless communication device 102 with a multi-band antenna system 106 supporting three common modes and one differential resonant mode. The multi-band antenna system 106 comprises a printed circuit board (PCB) 202 with a feeding contact 206, a conductor 208 that extends completely out of a PCB ground 204, wherein the conductor 208 has no ground contact with the PCB ground 204. The conductor has an enclosed slot 210. The conductor is fed with signals using a feed line 228 which is coupling the conductor 208 to the feeding contact 206.

### FIELD OF THE DISCLOSURE

The present invention generally relates to antennas and more particularly to a multi-band antenna system in a wireless communication device.

### BACKGROUND

In the present era, wireless communication devices are used almost everywhere. The wireless communication devices include an antenna system for transmitting and receiving signals. Due to globalization, wireless communication devices operate at multiple frequency bands which means they need multi-band antenna systems. A multi-band antenna system occupies a large volume in wireless communication devices and increases the overall size of the wireless communication devices and makes them bulkier and more inconvenient to carry. So, there is a need for a multi-band antenna system that may be used in wireless communication devices to make them thinner and more convenient to carry.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates a system diagram of a wireless communication network in accordance with some embodiments.

FIG. 2 illustrates a perspective view of an antenna system in accordance with some embodiments.

FIG. 3 illustrates a perspective view of an antenna system in accordance with some embodiments.

FIG. 4 illustrates a perspective view of a conductor in the antenna system in accordance with some embodiments.

FIG. 5 illustrates a perspective view of a conductor in the antenna system in accordance with some embodiments.

FIG. 6 and FIG. 7 illustrate a top and a bottom view respectively of an antenna system in accordance with some embodiments.

FIG. 8 illustrates a perspective view an antenna system in accordance with some embodiments.

FIG. 9 illustrates a perspective view an antenna system in accordance with some embodiments.

FIG. 10 is a return loss plot for the antenna system in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The system and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

A wireless communication device includes a multi-band antenna system that enables the wireless communication device to transmit and receive signals in the form of electromagnetic waves (EM waves) to and from a Base Transceiver Station (BTS). The multi-band antenna system includes a printed circuit board (PCB) with a PCB ground, a feeding contact lying on the PCB, a feed line, a conductor, and an optional matching circuit. The feed line couples the conductor to the feeding contact and transfers signals from the feeding contact to the conductor. The matching circuit is coupled between the feeding contact and the PCB ground and is used for matching impedance between the conductor and the feeding contact. The conductor is used to radiate EM waves and can be placed either completely outside the PCB ground or partially or completely overlapping the PCB ground. The conductor has at least one enclosed slot. The conductor takes no ground contact from the PCB ground and generally has a curved or a planar shape. The conductor may have a “C” or “U” shape, or may have another shape that extends in three-dimensional space. The enclosed slot of the conductor may extend throughout a length of the conductor or throughout a substantial portion of the conductor. The enclosed slot within the conductor may have “C” or “U” or “W” or any other shape. Apart from the enclosed slot, there can be other slots within the conductor that are not fully enclosed. These slots can have “T” or other shapes.

The antenna system disclosed above supports three common modes and a differential mode. These modes occur simultaneously, and the frequency spectrum of the antenna system is determined by a combined effect of these four modes resulting in quad band GSM. In the common mode, current flow is symmetric with respect to a central axis of the conductor. Whereas, in the differential mode, current flow is anti-symmetric with respect to the central axis of the conductor. There are several variable design parameters that may affect the characteristics of the modes of operation, such as spectral shape and operating bandwidth of the antenna system. These variable design parameters may include geometry and dimensions of the slot, geometry and dimensions of the conductor, and impedance matching techniques. The design parameters of the conductor are manipulated to match up to quad band GSM in the disclosed embodiments. The quad band GSM, for example, can be obtained using the disclosed antenna system whose volume is less than 1 cubic centimeter (cc). The volume of the disclosed antenna system can be more than 1 cc, if sufficient space for accommodating the antenna system in the wireless communication device is available. A wireless communication device using an antenna system having volume less than 1 cc could be thinner without sacrificing the bandwidth of the antenna system. In one of the embodiments, a reduction in the volume of the antenna system is achieved by positioning the conductor completely outside the PCB ground and this also helps in reducing the interference between the conductor and the electrical components on the PCB. Positioning the conductor outside the PCB ground may give room for connecting more electrical components on the PCB.

In other embodiments the antenna could be partially or completely overlapping the PCB ground while still providing a significant reduction in volume compared to other antenna structures such as the one described in U.S. Pat. No. 6,762,723. This description of the antenna system is applicable for most of the embodiments described in the application.

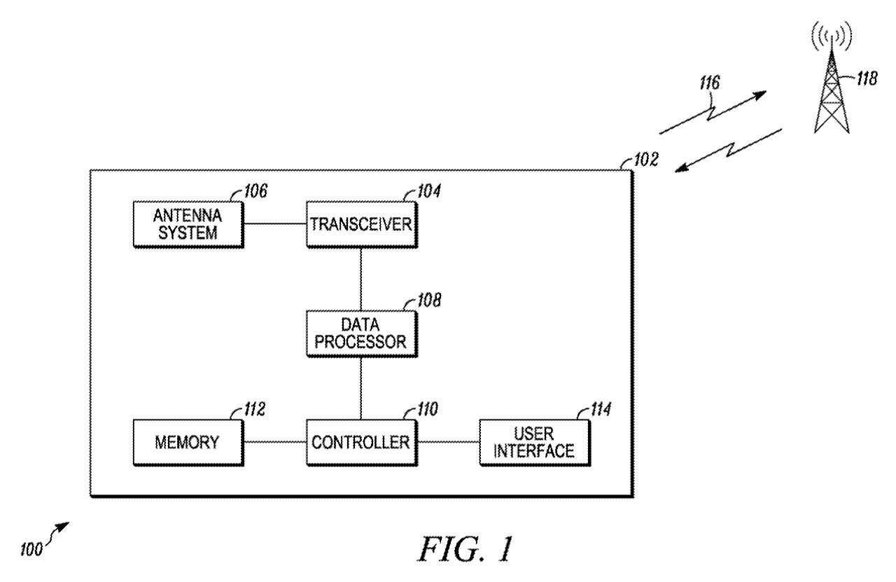

FIG. 1 illustrates a system diagram of a wireless communication network 100 in accordance with some embodiments. The wireless communication network 100 includes a base transceiver station (BTS) 118 and a wireless communication device 102. The wireless communication device 102 is sometimes referred to as user equipment (UE) in CDMA technology or a mobile station (MS) in GSM technology. The wireless communication device 102 can be a mobile phone, a laptop computer, a PDA, and the like. It could also be a remote controller, a gaming device, a cordless telephone, or a pager. The wireless communication device 102 includes a transceiver 104, an antenna system 106, a data processor 108, a user interface (UI) 114, a controller 110, and a memory 112. The UI 114 may include components such as a speaker, a microphone, a display, and a keypad.

The antenna system 106 in the wireless communication device 102 enables the wireless communication device 102 to transmit and receive signals in the form of electromagnetic waves (EM waves) 116 to and from the BTS 118. The BTS 118 is wirelessly connected to a Mobile Switching Center MSC (not shown in FIG. 1) to route the signals to other communication devices. The antenna system 106 is coupled to the transceiver 104 which is responsible for transmission and reception of signals from the antenna system 106. Alternatively, a transmitter circuit and a receiver circuit may be used in lieu of the transceiver 104.

The data processor 108 in the wireless communication device 102 is coupled to the transceiver 104 and to the controller 110. The data processor 108 converts the transmitted and the received signals from the transceiver 104 to digital data. The controller 110 in the wireless communication device 102 controls the UI 114 and the memory 112. While FIG. 1 shows the controller 110 being common to all the components of the UI 114, and to the memory 112, separate controllers may be used for individual components of the UI 114 and the memory 112 in some embodiments of the wireless communication device 102.

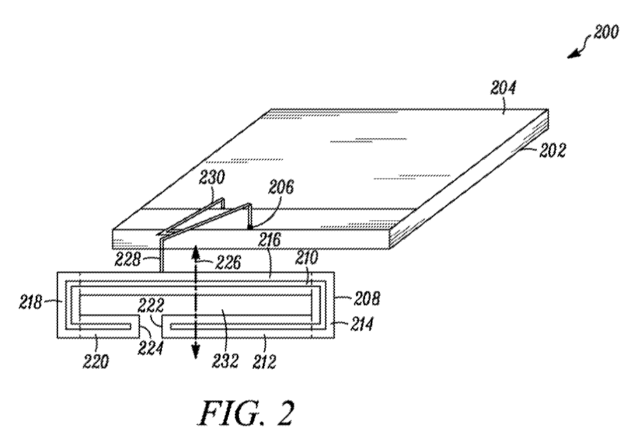

FIG. 2 illustrates a perspective view of an antenna system 200 in accordance with some embodiments. The antenna system 200 is a multiple frequency band antenna system or in other words, a multi-band antenna system. The antenna system 200 shown in FIG. 2 may be implemented in the wireless communication device 102 shown in FIG. 1. The antenna system 200 includes a printed circuit board (PCB) 202 with a PCB ground 204, a conductor 208, a feed line 228, a feeding contact 206, and a matching circuit 230.

The PCB 202 may be represented as a base to support and to connect various electrical components such as the transceiver 104, the data processor 108, the controller 110, the memory 112, and the UI 114 of the example wireless communication device 102 shown in FIG. 1. The PCB 202 may be a multi-layered PCB or a single layered PCB. The PCB 202 may be a rigid or a flexible PCB. In this example, the PCB 202 is a rectangular shaped multi-layered PCB. In another example, the PCB 202 may be tapered or rounded at its edges to conform to a shape of a housing of the wireless communication device 102.

The PCB ground 204 provides a common ground to the electrical components that are connected to the PCB 202. Portions of the PCB ground 204 may be present in multiple layers of the PCB 202. Alternatively, the PCB ground 204 may be included as one of the layers of a multi-layered PCB. The PCB ground 204 may be planar or curved according to the structure of the PCB 202. In some phone designs, such as clam shell phones or slider phones, a length of the PCB ground 204 may change as the orientation of phone parts is changed.

In addition to the PCB ground 204, the PCB 202 has the feeding contact 206 that transfers signals to the conductor 208 via the feed line 228. The PCB 202 is connected to the conductor 208 via the feed line 228. The conductor 208 is fed through the feed line 228 with signals from the feeding contact 206. The conductor 208 may also be referred to as a radiating element, because the conductor 208 radiates EM waves in space.

The conductor 208 has an enclosed slot 210 that helps the antenna system 200 to operate in multiple resonant bands. The enclosed slot 210 enables positioning of the different modes at the desired frequency bands for typical cellular multi-band operation. In an embodiment, a dielectric separation or gap between two or more portions of a contiguous conductor may be considered as a enclosed slot.

The slot 210 is enclosed in the conductor 208 and extends through a substantial portion of the conductor 208. The conductor 208 has a plurality of linear sections such as a first section 212, a second section 214, a third section 216, a fourth section 218, and a fifth section 220. All the sections of the conductor 208 lie in one plane in this embodiment. The enclosed slot 210 starts at a proximate distance from a first end 222 of the conductor 208 and runs throughout a length of the first section 212 of the conductor 208 and then enters the second section 214. Within the second section 214, the slot 210 curves at two right angles while it runs throughout a length of the second section 214 and then the slot 210 enters the third section 216. The slot 210 runs throughout a length of the third section 216 and enters the fourth section 218. Within the fourth section 218, the slot 210 curves at two right angles while it runs throughout a length of the fourth section 218 and then the slot 210 enters the fifth section 220. The slot 210 runs throughout a length of the fifth section 220 to reach a second end 224 of the conductor 208.

FIG. 2 also shows a T-shaped slot 232 in the conductor 208, wherein the T-shaped slot 232 lies in the same plane of the conductor 208 but is not an enclosed slot. The non-enclosed T-shaped slot 232 is asymmetrical with respect to a central axis 226 of the conductor 208. There may be other enclosed or non-enclosed slots with different geometries and they may be symmetrical or asymmetrical with respect to the central axis 226 of the conductor 208. The central axis 226 of the conductor 208 is defined as an axis that lies in the plane of the conductor 208 and is equidistant from the farthest points of the conductor 208. In an example, a length of the enclosed slot 210 is half the wavelength of a center frequency of a high frequency band at which the antenna system 200 is designed to operate. The width of the enclosed slot 210 in FIG. 2 is about 1 millimeter.

In other embodiments, there may be any number of sections in the conductor 208 that lie in a same plane. Sections in the conductor 208 may or may not have the same surface area. For example, the surface area of the first section 212 may be different from the surface area of the third section 216. In addition, the enclosed slot 210 may have different geometries such as a W-shape, a V-shape, or the like. The enclosed slot 210 may be symmetrical or asymmetrical with respect to the central axis 226 of the conductor 208. Although the enclosed slot 210 shown in FIG. 2 has a constant width, the width of the slot 210 may be variable.

The conductor 208 with the enclosed slot 210 may be symmetrical or asymmetrical with respect to the central axis 226 of the conductor 208. A symmetrical conductor is defined as a conductor that is divided into two similar conductors when the conductor 208 is bisected along the central axis 226. An asymmetrical conductor is defined as a conductor that is divided into two dissimilar conductors when the conductor 208 is bisected along the central axis 226. In an example, as shown in FIG. 2, the first section 212 is longer than the fifth section 220 which makes the conductor 208 asymmetrical. However the conductor 208 may be a symmetrical.

The conductor 208 extends completely outside space orthogonal to the PCB ground 204. The description “space orthogonal to the PCB ground 204” means the space covered by all planes that are parallel to a plane of the PCB ground 204 with the dimensions of all the planes confined by physical boundaries of the PCB ground 204. In other words, the conductor 208 lies outside the planes parallel to the plane of the PCB ground 204, wherein the planes parallel to the plane of the PCB ground 204 lie above and below the plane of the PCB ground 204. The “space orthogonal to the PCB ground 204” also means space directly above the face of the PCB ground 204 and space directly below the face of the PCB ground 204 confined by the physical boundaries of the PCB ground 204. The conductor 208 lying outside space orthogonal to the PCB ground 204 reduces volume of the antenna system 200 and also enables the antenna system 200 to achieve a quad-band GSM response. The volume of the antenna system 200 may be reduced to less than 1 cubic centimeter without sacrificing bandwidth of the antenna system 200. When the conductor 208 is placed outside the PCB ground 204, the interference between the conductor 208 and the electrical components of the PCB 202 is reduced and this may also leave space for connecting more electrical components on the PCB 202.

The conductor 208 shown in FIG. 2 does not take a connection from the PCB ground 204. Since the conductor 208 does not have a ground contact, it does not have a ground line connecting to the PCB ground 204 and, in this scenario, the antenna system 200 is excited by series excitation. The conductor 208 due to its geometry and position with respect to the PCB ground 204 (yet without a ground contact) provides three common modes and a differential mode. These four modes occur simultaneously and the frequency spectrum of the antenna system 200 is determined by a combined effect of the four modes resulting in quad band GSM.

The conductor 208 is coupled to the feeding contact 206 via the feed line 228 that transfers signals from the feeding contact 206 to the conductor 208. The feed line 228 may be meandered for matching impedance between the conductor 208 and the feeding contact 206. A feed may be centered or off-centered depending upon the position of the feed line 228 with respect to the central axis 226 of the conductor 208. An off-centered feed is positioned off the central axis 226 of the conductor 208 as shown in FIG. 2. On the other hand, a centered feed line is positioned on the central axis 226.

The conductor 208 (symmetrical or asymmetrical) and the feed position may determine which frequency bands are excited in the antenna system 200. In the example shown in FIG. 2, the conductor 208, which is an asymmetric conductor with an off-centered feed, helps the antenna system 200 to resonate in multiple frequency bands. In another example, an asymmetrical conductor with a centered feed or a symmetrical conductor with an off-centered feed may help the conductor 208 to resonate in the desired frequency bands.

In one of the embodiments as shown in FIG. 2, the matching circuit 230 couples the feeding contact 206 to the PCB ground 204 and is used for matching impedance between the conductor 208 and the feeding contact 206. In this embodiment, the matching circuit 230 may be a lumped shunt inductor. There may exist other ways for matching impedance between the conductor 208 and the feeding contact 206. In an example, the enclosed slot 210 in the conductor 208 may be used for matching impedance. The enclosed slot 210 in the conductor 208 changes the impedance of the conductor 208. So, the enclosed slot 210 may be introduced in such a way that the impedance of the conductor 208 matches with impedance of the feeding contact 206. In another example, as mentioned earlier, the feed line 228 may be meandered to match the impedance between the conductor 208 and the feeding contact 206.

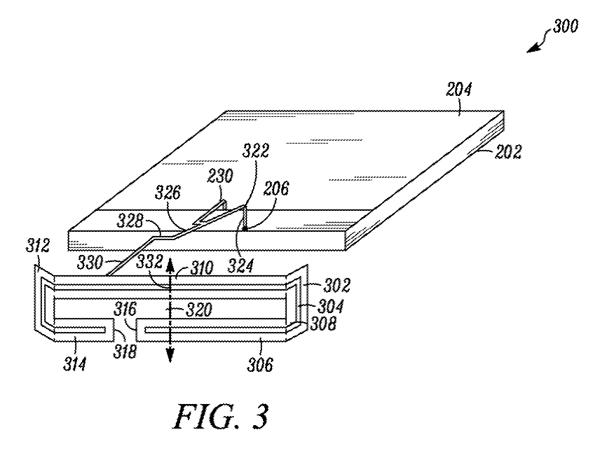

FIG. 3 illustrates a perspective view of an antenna system 300 in accordance with some embodiments. In the example, a conductor 302 shown in FIG. 3 is similar to the conductor 208 shown in FIG. 2 but is folded at the farthest sides to conform to the shape of the housing of the wireless communication device 102. The geometry of the conductor 302 shown in FIG. 3 helps reduce the volume of the antenna system 300. The antenna system 300 shown in FIG. 3 may be implemented in the wireless communication device 102 shown in FIG. 1.

In the example shown in FIG. 3, the conductor 302, which is asymmetrical with respect to a central axis 332 of the conductor 302, when fed with an off-centered feed helps the antenna system 300 to resonate in multiple frequency bands. The conductor 302 is fed with signals by the feeding contact 206 via a feed line 322. The matching circuit 230 couples the feeding contact 206 to the PCB ground 204 and is used for matching impedance between the conductor 302 and the feeding contact 206. In an embodiment, the matching circuit 230 may be a lumped shunt inductor.

Like the conductor 208 of FIG. 2, the conductor 302 shown in FIG. 3 includes a plurality of sections such as a first section 306, a second section 308, a third section 310, a fourth section 312, and a fifth section 314. The first section 306, the third section 310, and the fifth section 314 of the conductor 302 lie in the same plane. The second section 308 and the fourth section 312 lie in two different planes that are at a forty-five degree angle and at a hundred and thirty-five degree angle respectively with the above mentioned plane. The conductor 302 has a slot 304 enclosed in it. The enclosed slot 304 starts at a proximate distance from a first end 316 of the conductor 302 and runs throughout a length of the first section 306. At the end of the first section 306, the slot 304 follows a forty five degree angle of the second section 308 and runs throughout a length of the second section 308. Within the plane of the second section 308 the slot 304 curves at two right angles. At the end of the second section 308, the slot 304 follows another forty five degree angle of the third section 310 and runs throughout a length of the third section 310. In a similar manner, the slot 304 curves at forty five degree angle of the fourth section 312 and runs throughout a length of the fourth section 312. Within the plane of the fourth section 312, the slot 304 curves at two right angles. At the end of the fourth section 312, the slot 304 follows the forty five degree angle of the fifth section 314 and runs throughout a length of the fifth section 314 to reach near to a second end 318 of the conductor 302. FIG. 3 also shows a non-enclosed T-shaped slot 320 in the conductor 302, wherein the T-shaped slot 320 lies in the same plane that includes the first section, the third section 310, and the fifth section 314. The non-enclosed T-shaped slot 320 is asymmetrical with respect to the central axis 332 of the conductor 302.

In some embodiments, there can be any number of sections in the conductor 302 and the angles at which the sections are bent are variable based upon the overall design considerations of the wireless communication device 102. For example, the sections of the conductor 302 shown in FIG. 3 may have gentle arcs instead of straight-angle bends. Alternatively, the second section 308 of the conductor 302 may be curved at some angle and the fourth section 312 may be straight. Alternatively, the third section 310, the first section 306 or any other section of the conductor 302 may bend or curve at some angle. In another example, the fourth section 312 curves at some angle which is different from the angle with which the second section 308 curves. Sections in the conductor 302 may or may not have same surface area. For example, the surface area of the second section 308 may be different than the surface area of the fourth section 312. The slot 304 is enclosed in the conductor 302 and may have different geometries such as W-shape, C-shape, V-shape, and the like. The enclosed slot 304 may be symmetrical or asymmetrical with respect to the central axis 332 of the conductor 302. The enclosed slot 304 may be continuous in length or may be discontinuous so that there may be more than one enclosed slot in the conductor 302. Although the enclosed slot 304 shown in FIG. 3 has a constant width, alternatively, the width of the slot 304 is variable.

The conductor 302 is connected to the feed line 322 that transfers signals to the conductor 302 from the feeding contact 206. The feed line 322 may be meandered for matching impedance between the conductor 302 and the feeding contact 206. The feed line 322 is connected to the third section 310 of the conductor 302, wherein the third section 310 of the conductor 302 is the longest section among the other sections of the conductor 302. The feed line 322 extends in a three dimensional space and includes a plurality of portions such as a first portion 324, a second portion 326, a third portion 328, and a fourth portion 330. The second portion 326, the third portion 328, and the fourth portion 330 of the feed line 322 lie in the same plane which is perpendicular to a plane in which the first portion 324 lies. Each portion of the feed line 322 is at right angle to the next portion of the conductor 302. In some embodiments, the feed line 322 may include one or more portions that may be at different (non-right) angles to one another.

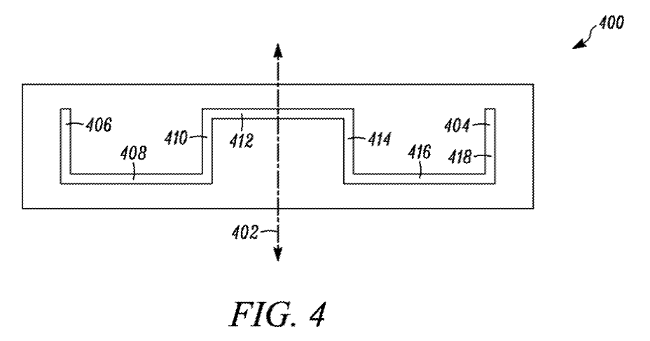

FIG. 4 illustrates a perspective view of a conductor 400 present in the antenna system 106 in accordance with some embodiments. Conductors shown in FIG. 2 and FIG. 3 are generally C-shaped conductors with an enclosed C-shaped and a non-enclosed T-shaped slot. Similarly, other geometries of the conductor 400 are possible. FIG. 4 shows an alternate conductor's geometry in which the conductor 400 is rectangular-shaped with a rectangular-W-shaped slot, and it may replace the conductor 208 shown in FIG. 2. The conductor 400 shown in FIG. 4 may also be implemented in the antenna system 106 that is present in the wireless communication device 102 shown in FIG. 1.

The conductor 400 in the example shown in FIG. 4 is symmetrical when bisected along a central axis 402 of the conductor 400. The conductor 400 is a rectangular shaped conductor and encloses a meandering slot 404 that has a plurality of linear segments. A shorter segment of the meandering slot 404 is parallel to a shorter side of the conductor 400 and there are four such shorter segments, i.e. a first segment 406, a third segment 410, a fifth segment 414, and a seventh segment 418. A longer segment of the meandering slot 404 is parallel to a longer side of the conductor 400 and there are three such segments shown, i.e. a second segment 408, a fourth segment 412, and a sixth segment 416. The first segment of the slot 404 curves at a right angle to form the second segment 408 of the slot 404 which then curves at right angle to form the third segment 410 of the slot 404. In a similar manner, each segment of the slot 404 curves at right angle to form the next segment of the slot 404. In another example, the meandering slot 404 may be serpentine in shape with any number of curves and the slot segments may curve at any angle relative to one another. In yet another example, the meandering slot may look more like a conventional “W” with ±30 degree angles between segments.

Although the meandering slot 404 shown has a constant width, alternatively, the width of the slot 404 may be variable. In some embodiments, the conductor 400 may have a shape other than the rectangular shape, such as C-shape, W-shape, and the like. The meandering slot 404 enclosed in the conductor 400 may also have different shapes such as C-shape, W-shape, and the like. The segments of the slot 404 may have straight-angle bends or gentle curves and the segments may curve at any angle (including non-right angles).

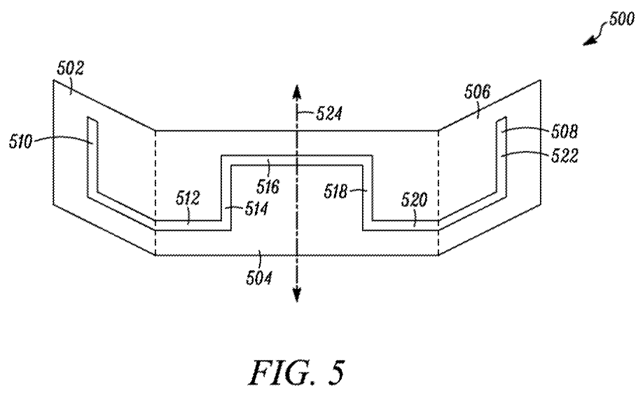

FIG. 5 illustrates a perspective view of a conductor 500 in the antenna system 106 in accordance with some embodiments. The conductor 500 shown in FIG. 5 is similar to the conductor 400 shown in FIG. 4 but with bends to conform it to the shape of the housing of the wireless communication device 102. This geometry of the conductor 500 shown in FIG. 5 helps reduce the volume of the antenna system. The conductor 500 shown in FIG. 5 extends in a three dimensional space with an enclosed rectangular-W-shaped slot. The conductor 500 shown in FIG. 5 may replace the conductor 302 of the antenna system 300 shown in FIG. 3.

The conductor 500 in the example shown in FIG. 5 is symmetrical when bisected along a central axis 524 of the conductor 500. The conductor 500 includes a plurality of sections such as a first section 502, a second section 504, and a third section 506, and the conductor 500 extends in a three dimensional space. The first section 502 of the conductor 500 lies in a plane which is at a hundred and twenty degree angle to a plane in which the second section 504 of the conductor 500 lies. Similarly, the third section 506 lies in a plane which is at a thirty degree angle to the plane of the second section 504. Each section of the conductor 500 is a planar rectangular-shaped section. The conductor 500 has an enclosed slot 508 which has a plurality of segments. The first section 502 of the conductor 500 includes a first segment 510 of the slot 508. The second section 504 includes a second segment 512, a third segment 514, a fourth segment 516, a fifth segment 518, and a sixth segment 520 of the slot 508. The third section 506 includes a seventh segment 522 of the slot 508. The first segment 510 of the slot 508 is formed in the first section 502 of the conductor 500 and has a right angle curve in it. At the end of the first section 502, the first segment 510 of the slot 508 follows a thirty degree angle of the second section 504 of the conductor 500 and forms the second segment 512 of the slot 508. The second segment 512 of the slot 508 curves at a right angle to form the third segment 514 of the slot 508. Similarly, within the second section 504 of the conductor 500 each segment of the slot 508 curves at right angles to form a next segment of the slot 508. At the end of the second section 504 of the conductor 500, the sixth segment 520 of the slot 508 follows a thirty degree angle of the third section 506 of the conductor 500 and forms a seventh segment 522 of the slot 508. The seventh segment 522 of the slot 508 has a right angle curve in it.

In some embodiments, there may be any number of sections in the conductor 500 and the angles at which the sections are bent may be variable based upon the overall design considerations of the wireless communication device 102. The conductor 500 may be symmetrical or asymmetrical with respect to the central axis 524 of the conductor 500. For example, the sections of the conductor 500 shown in FIG. 5 have gentle arcs instead of straight-angle bends. Alternatively, the third section 506 of the conductor 500 curves at some angle and the fourth section 312 may be straight. In another example, the third section 506 curves at some angle which is different from the angle with which the first section 502 curves. Sections in the conductor 500 may or may not have same surface area. For example, the surface area of the first section 502 may be different than the surface area of the third section 506. The slot 508 is enclosed in the conductor 500 and may have different geometries such as W-shape, C-shape, and the like. The enclosed slot 508 may be symmetrical or asymmetrical with respect to the central axis 524 of the conductor 500. The enclosed slot 508 may be continuous in length or may be discontinuous so that there may be more than one enclosed slot in the conductor 500. Although the enclosed slot 508 shown in FIG. 5 has a constant width, alternatively, the width of the slot 508 can be variable.

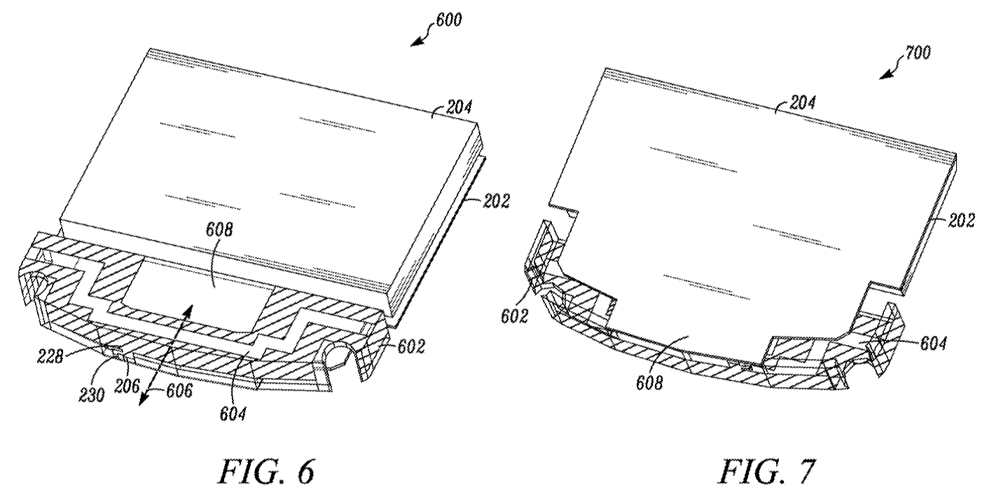

FIGS. 6-7 illustrate a top view 600 and a bottom view 700 of an antenna system in accordance with some embodiments. Conductors shown in FIGS. 2-5 are generally C-shaped or rectangular-shaped conductors with an enclosed slot. FIG. 6 shows an alternate conductor's geometry in which the conductor 602 is a C-shaped conductor with curved edges (instead of straight edges as shown in previous embodiments illustrated in FIG. 3 and FIG. 5) and with a C-shaped slot 604 enclosed in it. The conductor 602 is placed marginally overlapping space orthogonal to the PCB ground 204, and the PCB ground 204 extends into a void of the C-shaped conductor as shown more clearly in FIG. 7. By extending the PCB ground 204 with a ground tongue 608 where the PCB ground 204 is not in contact with the conductor 602, there is more surface area for the electrical components of the wireless communication device 102 and yet interference caused by the electrical components can be minimized. The ground tongue 608 is made to be conformal to the housing of the wireless communication device 102. The conductor 602 completely overlaps the ground tongue 608 and is conformal to the housing of the wireless communication device 102. The ground tongue 608 can be of any other shape then what is shown in the FIGS. 6 and 7. The conductor 602 is symmetrical about its central axis 606 and is fed with an off-centered feed line 228 that helps the antenna system to resonate in multiple frequency bands. The matching circuit 230 is coupled between the feeding contact 206 to the PCB ground 204 and is used for matching impedance between the conductor 602 and the feeding contact 206.

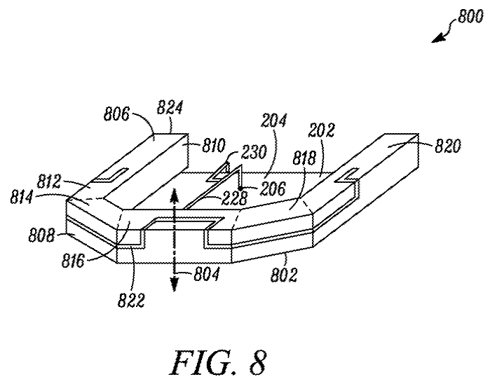

FIG. 8 illustrates a perspective view of an antenna system 800 in accordance with some embodiments. A conductor 802 shown in FIG. 8 is obtained by bending the conductor 500 shown in FIG. 5 in different directions for further reduction in the volume of the antenna system 800 and to conform to the housing of the wireless communication device 102.

In the example shown in FIG. 8, the conductor 802 which is symmetrical with respect to a central axis 804 of the conductor 802, when fed with an off-centered feed, helps the antenna system 800 to resonate in multiple frequency bands. The conductor 802 is fed with signals from the feeding contact 206 via the feed line 228. The conductor 802 partially extends into space orthogonal to the PCB ground 204. In other words, the conductor 802 partially overlaps the PCB ground 204 at the two terminal ends of the conductor 802. Alternatively, the conductor 802 can extend completely into space orthogonal to the PCB ground 204. The matching circuit 230 is coupled from the feed line 228 to the PCB ground 204 and is used for matching impedance between the conductor 802 and the feeding contact 206.

The conductor 802 has a plurality of faces such as an upper face 806, a side face 808, and a lower face (the lower face is hidden in FIG. 8) and the conductor 802 extends in a three dimensional space. The lower face of the conductor 802 is parallel to the upper face 806 of the conductor 802. The side face 808 of the conductor 802 is at a right angle to the upper face 806 and the lower face. Together these faces form a U-shaped conductor that extends in a three dimensional space and conforms to the shape of the housing of the wireless communication device 102. Space between the upper and the lower face of the conductor 802 may be filled with a dielectric 810 such as air, plastic, non-interfering electrical components, and/or the like. The conductor 802 includes a plurality of sections such as a first section 812, a second section 814, a third section 816, a fourth section 818, and a fifth section 820 that extend in a three dimensional space. The second section 814 of the conductor 802 is at forty-five degree angle to the first section 812 of the conductor 802. The third section 816 is at another forty-five degree angle to the second section 814 of the conductor 802. Similarly, the fourth section 818 is at a forty-five degree angle to the third section 816 and the fifth section 820 is also at forty-five degree angle to the fourth section 818 of the conductor 802.

The conductor 802 has an enclosed slot 822 in it that can generally be described as a rectangular-W formed along both the upper face 806 and the side face 808 of the U-shaped conductor 802. In the upper face 806 of the conductor 802, the slot 822 starts at a proximate distance from a first end 824 of the conductor 802 and take a right angle. Then, the slot 822 follows a right angle of the side face 808 of the conductor 802 and again curves at a right angle within the side face 808. Then the slot 822 follows the side face 808 of the conductor 802 to reach the third section 816 of the conductor 802 and then curves at a right angle within the third section 816 and extends in the upper face 806 of the conductor 802. In the upper face 806, the slot 822 takes three right angles and enters again in the side surface. Similarly, the slot 822 extends throughout a length of the conductor 802, as shown in FIG. 8.

In some embodiments, there may be any number of sections in the conductor 802 and the angles at which the sections are bent may be changed based upon the overall design considerations of the wireless communication device 102. The conductor 802 may be symmetrical or asymmetrical with respect to the central axis 804 of the conductor 802. For example, the sections of the conductor 802 shown in FIG. 8 may have gentle arcs instead of straight-angle bends. Alternatively, the second section 814 may curve at some angle which is different from the angle with which the fourth section 818 curves. Sections in the conductor 802 may or may not have same surface area. For example, the surface area of the first section 812 may be different than the surface area of the third section 816. The slot 822 is enclosed in the conductor 802 and may have different geometries such as W-shape, C-shape, and the like. The enclosed slot 822 may be symmetrical or asymmetrical with respect to the central axis 804 of the conductor 802. The enclosed slot 822 may be continuous in length or may be discontinuous so that there may be more than one slot in the conductor 802. Although the enclosed slot 822 shown in FIG. 8 has a constant width, alternatively, the width of the slot 822 can be variable.

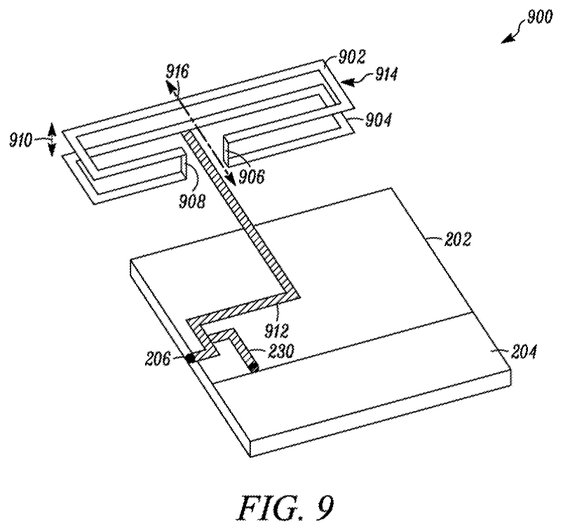

FIG. 9 illustrates a perspective view of an antenna system 900 in accordance with some embodiments. A conductor 914 shown in FIG. 9 is obtained by bending the conductor 208 shown in FIG. 2 in different directions for further reduction in the volume of the antenna system 900 and to conform to the housing of the wireless communication device 102.

In the example shown in FIG. 9, the conductor 914 which is asymmetrical with respect to a central axis 916 of the conductor 914 and, when fed with an off-centered feed, helps the antenna system 900 to resonate in multiple frequency bands. The conductor 914 is fed with signals from the feeding contact 206 via a feed line 912. The matching circuit 230 couples the feeding contact 206 to the PCB ground 204 and is used for matching impedance between the conductor 914 and the feeding contact 206.

The antenna system 900 in an example, as shown in FIG. 9, has the conductor 914 that includes a plurality of parts such as a first part 902, a second part 904, a third part 906, and a fourth part 908. The first part 902 and the second part 904 of the conductor 914 are co-extensive and are aligned in parallel to each other. The first part 902 and the second part 904 are planar or curved surfaces that are separated by a uniform gap. The antenna system 900 has an off-centered feed that helps the antenna system 900 to resonate in multiple frequency bands. The conductor 914 does not have a ground contact with the PCB ground 204 and extends completely outside space orthogonal to the PCB ground 204. The parts of the conductor 914 may have a cylindrical cross-section (such as a wire) or may be curved or be serpentine in shape so as to provide greater electrical length for the conductor 914.

The first part 902 and the second part 904 of the conductor 914 have a contour that may be termed a “C” shape. The third and the fourth parts of the conductor 914 are orthogonally coupled to the first part 902 and to the second part 904 of the conductor 914 respectively, at the termination points of the C-shapes. Although the shape of the first part 902 and the second part 904 of the conductor 914 is shown as a rectangular-C, alternate shapes can be tapered or trapezoidal, or have multiple non-right angles to become more curved, to fit to the shape of the housing of the wireless communication device 102. A slot 910 exists between the first part 902 and the second part 904 of the conductor 914 and, although it is shown as having a constant width due to a uniform gap, the slot 910 may be a non-uniform slot.

The second part 904 of the conductor 914 is coupled to the feed line 912. The feed line 912 may be meandered for matching impedance between the conductor 914 and the feeding contact 206. In an example, as shown in FIG. 9, the feed line 912 is a rectangular-Z-shaped feed line. Meandering the feed line 912 helps to change the impedance of the feed line 912 for matching purposes. The impedance of the feed line 912 is set in such a way that impedance between the conductor 914 and the feeding contact 206 is matched. The feed line 912 couples the second part 904 of the conductor 914 to the feeding contact 206. Alternatively, the feed line 912 may couple the first part 902 of the conductor 914 to the feeding contact 206. The matching circuit 230 is coupled between the feeding contact 206 to the PCB ground 204 and is used for matching impedance between the conductor 914 and the feeding contact 206. Alternatively, the matching circuit 230 can be multiple lumped elements that can be used for wideband matching.

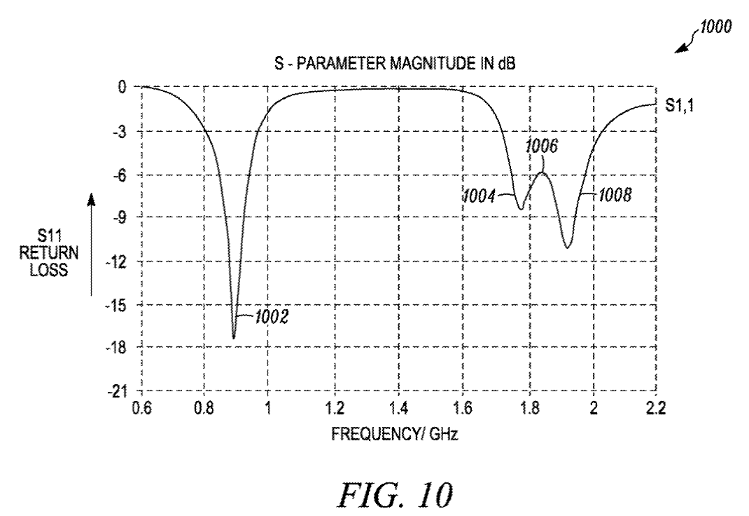

FIG. 10 is a return loss plot 1000 for the antenna system in accordance with some embodiments. Return loss shows dissimilarity between impedance of the feed line 912 and impedance of the conductor 914. A return loss value describes the reduction in the amplitude of the reflected energy, as compared to the forward energy. For example, if a device has 15 dB of return loss, reflected energy from that device is 15 dB lower than incident energy.

The return loss plot 1000 shown in FIG. 10 exhibits a first common mode in a first low frequency band 1002 with a resonant frequency centered at about 900 MHz and having a bandwidth ranging from 820 MHz to 980 MHz. The first frequency band covers two commercial GSM bands i.e. 850 MHz and 900 MHz. The return loss plot 1000 further exhibits a second common mode in a first high frequency band 1004 with a resonant frequency centered at about 1750 MHz and having a bandwidth ranging from 1700 MHz to 1800 MHz. A third common mode is also exhibited by the return loss plot 1000, in a second high frequency band 1008 centered at about 1940 MHz and having a bandwidth ranging from 1880 MHz to 1980 MHz. The second high frequency band may be used for GSM communications at frequency 1900 MHz. The return loss plot 1000 also exhibits a differential mode in a region 1006 between the first high frequency band 1004 and the second high frequency band 1008 with a resonant frequency centered at about 1850 MHz and having a bandwidth ranging from 1800 MHz to 1880 MHz.

The spectrum of FIG. 10 will typically shift down in frequency when the size of the slot 910 increases, and vice-versa. Proper impedance matching between the conductor 914 and the feeding contact 206 helps in widening the bandwidth of the frequency bands. Controlling a length and a width of the conductor 914, frequencies of the common mode and the differential mode are tuned to desired operating bands that are to be supported by the antenna system 900. All the embodiments discussed above would show a similar frequency spectrum as shown in FIG. 10.

In the foregoing specification, specific embodiments have been described. However, one of ordinary skill in the art appreciates that various modifications and changes may be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that “comprises”, “has”, “includes”, “contains” a list of elements may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus. The terms “a” and “an” are defined as one or more unless explicitly stated otherwise herein. The terms “substantially”, “essentially”, “approximately”, “about” or any other version thereof, are defined as “being close to” as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not described.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it may be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A wireless communication device having a multi-band antenna system comprising:
a printed circuit board (PCB) with a PCB ground and a feeding contact;
a conductor extending completely out of the PCB ground, wherein the conductor has no ground contact with the PCB ground;
at least one enclosed slot in the conductor; and
a feed line coupling the conductor to the feeding contact.

2. The wireless communication device of claim 1, wherein the conductor extends completely outside space orthogonal to the PCB ground.

3. The wireless communication device of claim 1, wherein the conductor partially extends into space orthogonal to the PCB ground.

4. The wireless communication device of claim 3, wherein the conductor extends completely into space orthogonal to the PCB ground.

5. The wireless communication device of claim 1, wherein the conductor is conformal to a housing of the wireless communication device.

6. The wireless communication device of claim 5, wherein the conductor has a curved shape extending in three dimensions.

7. The wireless communication device of claim 1, wherein the conductor is symmetrical with respect to a central axis and wherein the feed line is positioned at a point away from the central axis.

8. The wireless communication device of claim 1, wherein the conductor is asymmetrical with respect to a central axis of the conductor and wherein the feed line is positioned at a point away from the central axis.

9. The wireless communication device of claim 1, wherein the conductor is asymmetrical with respect to a central axis of the conductor and wherein the feed line is positioned at a point on the central axis.

10. The wireless communication device of claim 1, wherein the at least one enclosed slot extends through a substantial portion of the conductor in a three dimensional space.

11. The wireless communication device of claim 1, wherein the at least one enclosed slot substantially extends throughout a length of the conductor.

12. The wireless communication device of claim 1, further comprising:
a matching circuit coupled between the feeding contact and the PCB ground.

13. The wireless communication device of claim 1, wherein the feed line is meandered for matching impedance between the conductor and the feeding contact.

14. The wireless communication device of claim 1, wherein the multi-band antenna system supports a frequency spectrum comprising a first common mode in a first low frequency band, a second common mode in a first high frequency band, a differential mode in a region between the first high frequency band and a second high frequency band, a third common mode in the second high frequency band.

15. The wireless communication device of claim 1, wherein the multi-band antenna system has a volume less than 1 cubic centimeter.
